(19) United States
(12) Patent Application Publication
(10) Pub. No.: US 2008/0138883 A1
(43) Pub. Date: Jun. 12, 2008

(54) Method for Bioremediation and Biodegradable Product Therefor

(76) Inventor: William I. Young, North Scituate, MA (US)

Correspondence Address: BIRCH STEWART KOLASCH & BIRCH, PO BOX 747, FALLS CHURCH, VA, 22040-0747, US

(21) Appl. No.: 11/794,667

(22) PCT Filed: Oct. 28, 2004
(86) PCT No.: PCT/US04/35640

§ 371 Date: Jul. 3, 2007

Related U.S. Application Data
(60) Provisional application No. 60/515,023, filed on Oct. 28, 2003.

(51) Int. Cl. A62D 3/02

(52) U.S. Cl. 435/262.5

(57) ABSTRACT

A product for bioremediation, comprising a biodegradable carrier and a tablet or powder consisting essentially of microorganisms capable of digesting hydrocarbons, an inert material, and optionally trace oil in an amount sufficient to maintain the microorganisms in a dormant state, said microorganisms located entirely within said biodegradable carrier, and wherein the biodegradable carrier is directly in contact with the microorganisms.

### CROSS-REFERENCE TO RELATED APPLICATIONS

This application claims benefit under 35 U.S.C. § 119(e) of U.S. Provisional Application No. 60/515,023 filed Oct. 28, 2003, the contents of which are hereby incorporated by reference.

### BACKGROUND OF THE INVENTION

1. Field of the Invention

The present invention relates to a method for bioremediation of a polluting substance, which method utilizes a microorganism, preferably from the domain Archaea. The present invention also provides a product for bioremediation, comprising a microorganism, preferably from the domain Archaea, and a biodegradable carrier.

2. Description of Related Art

Pollution of the earth's environment by harmful and non-decomposable contaminants is a major concern posing a threat to the health and safety of all living creatures. For example, contamination of the world's water resources presents a global environmental hazard. Both commercial and non-commercial shipping vessels generate millions of gallons of hazardous pollutants, including petroleum hydrocarbons. Accidental spills of oil from pipelines, supertankers, land-based tanker trucks, etc. also have resulted in devastation to both marine and terrestrial life.

There is a well-recognized need for remediation, or the clean up, of pollutants that exist in a variety of settings, including water, soil, and sediment collections.

Currently, the majority of petroleum wastes are processed via mechanical means, including confinement booms, surface-skimmers, oil-water separators, etc. However, these mechanical methods of petroleum contaminant reduction generally do not sufficiently reduce the levels of petroleum deposits in solution sufficient to protect the environment. For example, a problem known with mechanical confinement technologies is that concentrations of petroleum hydrocarbon contaminants remaining in the water phase often exceed the regulatory-allowed limits for discharge into open waters.

Since the 1970's, the new technology of bioremediation has evolved wherein naturally occurring microorganisms, such as bacteria, are utilized to actively consume toxic hydrocarbon compounds and transform them into harmless byproducts. Bioremediation takes place when microorganisms are activated and exposed to targeted hydrocarbons or organic compounds and convert them into products such as water-soluble fatty acids, carbon dioxide, water, oxygen, and trace carbon. Bioremediation was successfully utilized during the removal of the Exxon Valdez oil spill.

Although various mechanical and biochemical means for removal of hydrocarbon pollution are known, few are satisfactory in the perspective of cost, ease of operation, and efficiency. All of the systems have drawbacks and limitations. In some cases, the limitations relate to the degree of removal that can be accomplished with a specific system or piece of equipment. In others, the application of high concentrations of bacteria to a particular polluted area has resulted in secondary pollution due to diffusion of the bacteria to adjacent areas.

Furthermore, typical products for bioremediation on the market today require extensive packaging and delivery systems that often must be removed from the contaminated site after the bioremediation has taken place. For example, U.S. Pat. No. 6,573,087 B2 (issued Jun. 3, 2003) to Lehr describes timed-released microorganisms packaged in an absorbent matrix for the degradation of hydrocarbons. In the preferred embodiment thereof, a core member, which contains bacteria capable of degrading hydrocarbons, is surrounded by a matrix of a high absorbency cellulose or melt blown polypropylene material which wicks and stores accumulated hydrocarbons for contact with the core member, thereby accomplishing controlled release of the bacteria. Furthermore, the matrix itself is covered with an outer casing preferably of cotton textile material.

U.S. Pat. No. 5,658, 795 (issued Aug. 19, 1997) to Kato et al. describes a method for biodegradation of a polluting substance wherein a biodegradable carrier is utilized to support an auxotrophic microorganism. The use of a biodegradable material eliminates the problems associated with secondary pollution caused by remaining carrier and damage to the ecosystem caused by the applied microorganism.

Kato et al. requires the use of auxotrophic bacteria, i.e., bacteria which has lost a metabolic system or biosynthetic system of a certain nutrient and is incapable of producing the nutrient, which requires the supplementation of the nutrient necessary for living and multiplying. Thus, the carrier for the microorganism must also contain the required nutrient, which may be one or more amino acids, nucleic acid bases, vitamins, organic acids, or other growth factors. Without the addition of the nutrient, the bacteria will quickly become extinct without eliminating the hydrocarbon pollutant.

The present invention provides a method for bioremediation wherein the problems of the prior art are solved. Specifically, the present invention provides a product for bioremediation which is completely biodegradable, thereby solving the problem of secondary pollution. The product of the present invention allows targeted delivery of microbes to contaminated areas to reduce hydrocarbons to environmentally acceptable byproducts, while leaving no resultant waste requiring clean up. The present invention is also extremely simple and cost-effective in its production. The present invention utilizes a microorganism which is not auxotrophic and therefore does not require any additional nutrients in the biodegradable carrier to survive. The lack of necessity of a nutrient in the carrier avoids an extra step in production which is undesirable from a cost and efficiency standpoint. The microorganism is preferably from the domain Archaea, which is more effective than any known bacterium used for bioremediation.

### BRIEF SUMMARY OF THE INVENTION

The present invention provides a product for bioremediation, comprising a biodegradable carrier and a tablet or powder consisting essentially of microorganisms capable of digesting hydrocarbons, an inert material, and optionally trace oil in an amount sufficient to maintain the microorganisms in a dormant state, said microorganisms located entirely within said biodegradable carrier, and wherein the biodegradable carrier is directly in contact with the microorganisms. The microorganisms are preferably from the domain Archaea. The biodegradable carrier is preferably a starch, such as cornstarch, or rice paper, and may contain a hole, slit, opening, pore, etc. The product may also contain a fragrance. The present invention provides a method for bioremediation, comprising the steps of delivering the product described above to a contaminated site, allowing the biodegradable carrier to dissolve, allowing the hydrocarbons to access the microbes, and allowing the microbes to be released into the contaminants to convert the contaminants to natural byproducts. The present invention also provides a method for removing or neutralizing odors in a holding tank, such as a tank in a RV or the bilge area of a ship, comprising the steps of delivering the product described above to a holding tank, allowing the biodegradable carrier to dissolve, allowing the hydrocarbons to access the microbes, and allowing the microbes to be released into the contaminants to remove or neutralize the odors to natural byproducts.

The present invention also provides a process for producing a product for bioremediation, comprising the steps of: admixing microorganisms capable of digesting hydrocarbons with an inert material and optionally trace oil in an amount sufficient to maintain the microorganisms in a dormant state, to form a mixture; placing the mixture into preformed holes of a tablet-making template, wherein the tablet-making template is a foam; placing the tablet-making template onto a compression press; applying pressure to the tablet-making template to form tablet; extracting the tablet from the tablet-making template; and placing the tablet into a biodegradable carrier wherein the biodegradable carrier surrounds the microorganisms and is in direct contact with the tablet. The microorganisms are preferably from the domain Archaea. The biodegradable carrier is preferably a starch, such as cornstarch, or rice paper. The process described above may also include the steps of inserting a hole, slit, opening, pore, etc. into the biodegradable carrier, or adding a fragrance therein. The present invention also relates to a product for bioremediation produced by the process described above.

The present invention also provides a method for bioremediation comprising the steps of providing microorganisms capable of degrading hydrocarbons in the form of a tablet or powder, incorporating said microorganisms into a biodegradable carrier, wherein the tablet or powder is in direct contact with the biodegradable carrier, delivering the biodegradable carrier containing the microorganisms to a contaminated site, wherein the biodegradable carrier is dissolved or disintegrated, thereby releasing the microorganisms which bioremediate at the contaminated site. The microorganisms are preferably from the domain Archaea. The biodegradable carrier is preferably a starch, such as cornstarch, or rice paper, and may contain a hole, slit, opening, pore, etc. The product may also contain a fragrance.

### BRIEF DESCRIPTION OF THE DRAWINGS

FIG. 1 is an exterior view of the product of the present invention.

FIG. 2 is a cross-sectional view shown along cut line 2 of FIG. 1. The interior 1 is made up of microorganisms in an inert material (e.g., clay or bentonite clay) and optionally trace crude oil in an amount sufficient to maintain the microorganisms in a dormant state. The biodegradable carrier 2 is in direct contact with, and completely surrounds, the interior powder or tablet.

FIGS. 3A and 3B represent cross-dimensional views of a biodegradable cornstarch sheet 3 into which microbes 5 are placed and sealed.

FIG. 4 is a three-dimensional view of the tablet-making template containing holes 6.

FIG. 5 shows microbe-bearing biodegradable carriers 7,8 suspended by tethers 9,10.

FIG. 6 shows microorganisms 11 in a compressed tablet or powder form between dissolvable paper sheets 12 suspended by a tether 13.

FIG. 7 is a two-part dissolvable gel-pack capsule containing microbes.

FIG. 8 is a tablet-wrapping machine showing dispensed tablets being encased in biodegradable cornstarch paper wrapping.

FIG. 9 is a series of fluted, biodegradable, cornstarch cylinders into which microbes are placed and sealed by biodegradable sheets at the ends of the cylinders.

FIG. 10 is a packet-making machine showing dispensed packets of microorganisms encased in biodegradable cornstarch paper wrapping.

### DETAILED DESCRIPTION OF THE INVENTION

The present invention relates generally to bioremediation of pollutants on land and in standing or moving water, and specifically to bioremediation of hydrocarbon and organic pollution in fresh and salt water. The invention relates to a biodegradable microorganism-containing product and method of use thereof for removing hydrocarbons from ship vessel bilges, and for cleaning up hydrocarbon spills and deposits on water, for example in catch basins, septic tanks, and grease traps. The present invention also provides a method to eliminate odors such as those that occur in holding tanks, septic systems, grease traps, etc. The microorganism utilized in the present invention is preferably from the domain Archaea. The invention provides a new method and product for bioremediation without introducing into the environment materials which require removal, destruction or cleanup, such as barriers, entrapment, absorbent, or adsorbent devices or materials, and oil-soaked confinement booms or rags. The product of the present invention allows targeted delivery of microbes to contaminated areas to reduce hydrocarbons to environmentally acceptable byproducts, while leaving no resultant waste requiring clean up.

The present invention also relates to the packaging of microorganisms into a product for release of oil-eating microbes (e.g., millions to trillions) into hydrocarbon contamination or sewage. It combines microbes, either as a tablet or powder directly in contact with a biodegradable carrier to achieve bioremediation without producing unwanted debris. In other words, no matrix (absorbent or otherwise) is necessary to wick hydrocarbons to the oil-eating microbes. Preferably, the invention further does not require the addition of a nutrient for survival of the microorganism, other than an optional trace oil in an amount sufficient to maintain the microorganisms in a dormant state. The lack of necessity of an additional nutrient in the carrier avoids an extra step in production which is undesirable from a cost and efficiency standpoint. The lack of any additional binders, additives, etc. (other than, those in which the microorganisms are commercially packaged) allows for a 100% pure concentration of microorganisms to be exposed to the pollutants. The microbes are preferably from the domain Archaea.

This invention may be used in the bilge area of both commercial and recreational boats, in military vessels, in marinas, in holding tanks, in cooling tanks, in recreational vehicles (“RVs”), in papermaking plants, in gas production and oil refinery plant sites, in polluted areas restricted by floating booms, in kitchen-waste grease traps, in water run-off catch basins, in waste water, in wetlands, streams, lakes, rivers, underground water, oceans, and any other waters of the world, in polluted soil, waste-treatment sites, farms, i.e., anywhere pollutant hydrocarbons are present and undesired.

### The Microorganism

The present invention may utilize any microorganism known for its ability to remediate, or digest, hydrocarbons. The source of the microorganisms is not limited, so long as the microorganism has the ability to remediate the pollutant to be removed. The microorganism is preferably not auxotrophic.

The inventor of the present invention recognized the application of microorganisms from the domain Archaea as a preferable element of his invention. It is known in the art that there are three major groups of prokaryotes, i.e., bacteria, Archaea, and Eukarya, which are classified based upon comparative genetic analysis of the nucleotide sequences of their small subunit ribosomal RNA (ssrRNA). In addition to differences in ssrRNA, microorganisms of domain Archaea also possess unifying archaeal features (i.e., no murein in cell wall, ester-linked membrane lipids, etc.) that differentiate them from bacteria. Many of these unique structural and biochemical attributes allow microorganisms of the domain Archaea to live in extreme habitats, including very high temperatures (hyperthermophiles) and very high concentrations of salt (extreme halophiles).

In a preferred embodiment, MicroSorb® microbial products, sold by Microsorb Environmental Products, Inc. of Norwell, Mass. is the source of hydrocarbon digesting microorganisms used in the present invention. MicroSorb® is designed to optimize the recycling phenomena with the addition of oil-eating microbes. MicroSorb® microbial products contain naturally occurring microbes of the domain Archaea that convert hydrocarbon contaminants into non-toxic components, thereby eliminating the problem of disposal.

MicroSorb® microbial products are available in three grades: MicroSorb® ER (Emergency Response), MicroSorb® IS (Industrial Strength), and MicroSorb® SC (Super Concentrate). MicroSorb® ER is particularly useful for oil and chemical surface spill treatment, and can be used to attack any petroleum based liquids (i.e., gasoline, fuel oil, and hydrocarbon solvents), virtually any hydrocarbon, and oxygenated hydrocarbon. MicroSorb® ER contains a consortium of over 140 billion hydrocarbon digesting microbes per ounce contained in bentonite clay carrier. MicroSorb® ER is utilized to contain (absorb) and treat sudden surface spills or low level historical releases (weeping) on natural surfaces (i.e., soil), treat oily buildup or sudden spills on concrete or other man-made surfaces to eliminate oil and oil odors, reduce slippery conditions, or for repainting surfaces, treat oily sheens on surface water, and initially treat open contaminated trenches, pits, or excavations for localized and cost-effective bioremediation.

MicroSorb® IS is particularly useful for bioremediation of organic matter, and can be used to attack any petroleum based liquids (i.e., gasoline, fuel oil, hydrocarbon solvents) and organic wastes), as wells as virtually any hydrocarbon and oxygenated hydrocarbon. MicroSorb® IS contains a consortium of over 560 billion hydrocarbon digesting microbes per ounce contained in bentonite clay carrier. MicroSorb® IS is utilized in the treatment of poultry grow-out houses for reduced odor, reduced wastes, and healthier, quicker grow-out conditions, for a more rapid cleanup of surface releases (versus MicroSorb® ER) when time is of the essence, in the treatment of septic tanks and leaching fields. MicroSorb® IS also works to reduce organic waste buildup in the tank and prevent grease and other fouling agents from entering the leaching field. MicroSorb® IS also treats surface water spills to contain and break down floating hydrocarbons.

MicroSorb® SC is a super concentrated microbial consortium particularly useful for bioremediation in oxygen-limiting environments, and can be used to attack any petroleum based liquids (i.e., gasoline, fuel oil, hydrocarbon solvents) and organic wastes), as well as virtually any hydrocarbon and oxygenated hydrocarbon. MicroSorb® SC contains a consortium of over 2.5 trillion hydrocarbon digesting microbes per ounce contained in bentonite clay carrier. MicroSorb® SC, because of its high microbe content, has the ability to attack hydrocarbons in oxygen limited environments, such as below grade and in groundwater. MicroSorb® SC is utilized in the treatment of subsurface in situ soil and/or groundwater contamination. MicroSorb® SC is also ideal for treating contamination near building foundations, tanks, or utilities where contamination removal may damage structures, for treating stockpiled (ex situ) contaminated soil, for direct application to septic systems and grease traps to lower solids buildup, reduce odors, and break down fats, oil, and grease. MicroSorb® SC may also be used in sewerage lift stations, piping, and wastewater treatment plants to reduce odors, limit corrosion, and lower solids disposal costs, in manure treatment (chickens, hogs, and cattle) to reduce solids, eliminate odors and ammonia, and improve livestock health and grow-out. MicroSorb® SC is particularly useful for the bioremediation of waste traps in RVs.

In the present invention, the microorganisms, such as those contained in the MicroSorb® family of products, are preferably contained in an inert preparation of inorganic material (e.g., natural clay). Further, a trace amount of oil (e.g., crude oil or oil on which the microorganisms are weaned) is present in the preparation in order to maintain the microorganisms in a dormant state for storage, transport, etc. However, the present invention does not require the addition of any additional nutrient to the biodegradable carrier, tablet/powder, and/or inert material, such as one or more amino acids, nucleic acid bases, vitamins, organic acids, or other growth factors in order to maintain viability of the microorganisms. Preferably, no enzymes are present in the biodegradable carrier and/or inert preparation. This preparation may be compressed into tablets which absorb water and hydrocarbons

The tablets dissolve and release the microbes into the contaminant during remediation. The microbes are activated and consume and convert the contaminant into natural byproducts, such as fatty acids, carbon dioxide, water, etc. Once the contaminants have been exhausted, the microbes will either die, return to former natural concentration levels, or be eaten by other organisms.

As noted above, the present invention may utilize any microorganism known for its ability to remediate, or digest, hydrocarbons. Examples of such microorganisms are bacteria such as Pseudomonas sp., Acinetobacter sp., Metyiosinus sp. and the like which exhibit activities of pollutant-decomposition are suitable for removal of dyes having an aromatic ring or furan structure, pigments, surfactants, surface-coating agents, adhesives, organic solvents, petroleum type pollutants, etc. In addition, oil-eating microbes, such as those commercially available from Oppenheimer Biotechnology Inc. of Austin, Tex., (i.e., the Oppenheimer Formula), which have been collected from natural water and soil sources from around the world, have a particular affinity for consuming hydrocarbon-based products. These microbes may also be used in the method and product of the present invention.

Several other microorganisms suitable for use in the present invention are described in U.S. Pat. No. 3,843,517, the contents of which are hereby incorporated by reference.

### The Product

The present invention also provides a product for bioremediation, comprising a microorganism, preferably from the domain Archaea, and a biodegradable carrier. The microorganism is preferably contained in an inert material (e.g., clay), which also contains a trace amount of oil (e.g., crude oil) in an amount sufficient to maintain the microorganisms in a dormant state. The product for bioremediation can be prepared as follows.

The microorganisms are initially housed in an inert material, such as clay or a bentonite clay mixture, which degrades upon contact with water, releasing the microbes. The inert material preferably contains a trace amount of crude oil (e.g., only an amount sufficient to maintain the microorganism in a dormant state). As used herein, “trace amounts” also refers to an insignificant amount, or an amount not visible to the eye or readily measurable, or an amount of oil that is so small that it does not add any significant amount of oil to the hydrocarbon to be remediated. In a preferred embodiment, tablets of the microbes held in this inert material (e.g., clay) are completely enclosed within a biodegradable carrier, which will also suitably degrade when in contact with water.

The microorganisms may be prepared in tablet form together with an inert carrier by use of a pill-making machine, which preparation is conventional in the art. Preferably, however, the present invention provides a novel, cost-effective, and simple method for preparing the microorganisms in tablet form. Specifically, the present invention utilizes a tablet-making template and a compression press to create the tablets. This unique method for forming tablets does not require the use of any additional binders or additives other than those (e.g., clay and trace amounts of crude oil) in which the microorganisms are commercially packaged, so that the concentration levels of the microorganism are not compromised.

In a preferred embodiment, the tablet-making template is a piece of foam having the following characteristics: resiliency, flexibility, tear-resistance, and chemical suitability for the microorganism. The tablet-making template is preferably cross-linked polyethylene foam. The tablet-making template can be made of different densities and different foams such as polyethylene, polyurethane, polypropylene, or rubber. Typical examples of such a foam are Volara Type A®, a flexible closed cell irradiation cross-linked polyethylene foam, and Minicel L200® and L300®, closed cell chemically cross-linked polyethylene foams. These products are commercially available from Voltek (Lawrence, Mass.). Suitable cross-linked polyurethane foams are also commercially available from Cellect LLC (St. Johnsville, N.Y.).

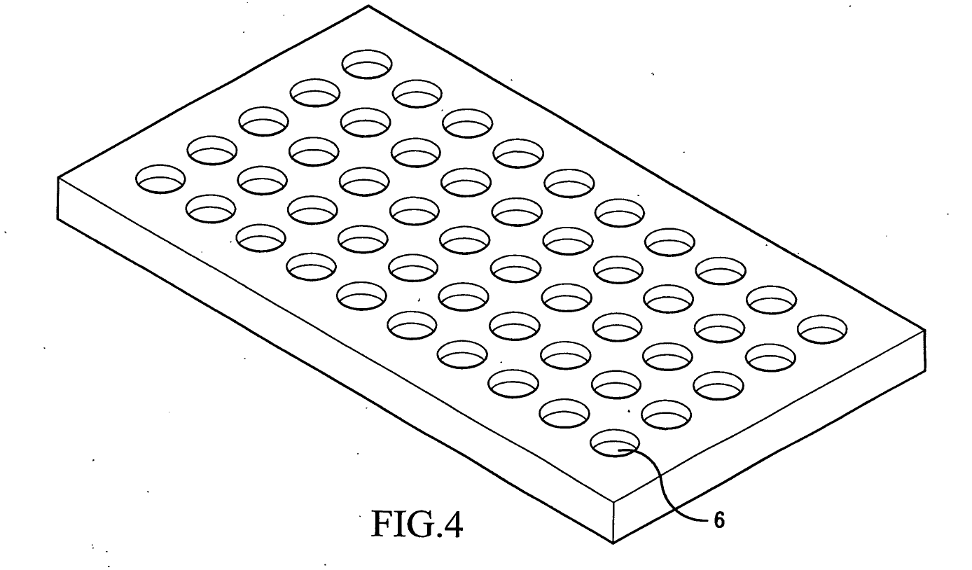

A typical tablet-making template, shown in FIG. 4, is approximately 10×5.5×⅜″. The template is impregnated with holes 6 approximately ⅝″ wide in which the tablets are to be formed. The skilled artisan would understand that the size and thickness of the template, as well as the depth, diameter, and shape of the holes, may be varied in order to achieve different results. For example, the holes may be varied in order to make different dimensions, sizes, and thickness of the tablets, which in turn affects the properties of the tablets.

The microorganisms are preferably admixed with an inorganic inert material (e.g., clay) and placed into the holes of the tablet-making template. The template is placed onto a commercial compression press. The type of compression press could be a Hudson or Samco or any other press similar to what the industry knows as a die cutter or a compression machine. Approximately 10-40 tons, and preferably 20-30 tons, of pressure is applied to the tablet-making template of the size 10×5.5×⅜″. The amount of pressure may be increased or decreased depending on the size of the tablet-making template utilized. A mixture of microorganisms in an inert material, preferably with trace amount of crude oil, are spread into the holes of the template and the press is then activated, which compress the foam thereby forming the microorganisms into tablets. The tablets are then extracted from the holes and placed into a biodegradable carrier. When extracted, the tablets may be, in general, slightly larger than the holes of the template due to the flexibility of the foam.

The method of the present invention provides microorganisms in a tablet form wherein the number of microorganisms living is surprisingly greater than with known tablets. These surprisingly good effects of the inventive method lies in the fact in that the foam of the tablet-making template absorbs the shock and heat of the compression, thereby not killing the microorganisms in the holes. The template is resilient and flexible and spreads the load of the compressor over the full surface of the template, thus putting less pressure on each tablet.

The invention includes implementing a biodegradable carrier to support the hydrocarbon-digesting microbes. When placed in solution, the carrier will break up, dissolve, and eventually degrade. The microbes will be exposed to, for instance, the hydrocarbons and digest the hydrocarbons and odors.

The material for the biodegradable carrier includes, for example, cellulose, lignin, starch, agarose, dextran, albumin, chitin, chitosan, filter paper, wood pieces, etc. Typical starches include cornstarch, laundry starch, potato starch, rice starch, and tapioca starch. As defined herein, the biodegradable carrier does not contain wax. A carrier made of such a material is preferred since it encases the microorganism, releases the microorganism relatively readily, is inexpensive, and in some cases, serves as a nutrient for the microorganism itself. A preferred biodegradable carrier is starch, and even more preferably, cornstarch. Another preferred biodegradable carrier is rice paper.

A preferred biodegradable carrier is Green Cell sheets, which is a starch-based material supplied by KTM Industries, Inc. of Lansing, Mich. That material or similar material has about 90% or greater cornstarch content and about 1-10% of a degradable binder. Methods and materials for manufacturing starch capsules are disclosed in U.S. Pat. No. 6,669,962 to Fanta et al., the contents of which are hereby incorporated by reference.

Another embodiment has the microbes stored in a gel-pack container, made from an environmentally friendly gelatin or cellulose derivative. These dissolvable containers can be used for targeted microbe delivery.

Another embodiment has the microbes stored in other biodegradable carriers, such as tallow, fish entrails, algae, seaweed and seaweed extracts, such as alginates and carageenans, polysaccharides, water-soluble polymers, and plant extracts (e.g., vegetable matter), such as konjac, petin, arabinoglactan, etc.

Examples of water-soluble polymers are pullulan, hydroxypropylmethyl cellulose, hydroxyethyl cellulose, hydroxypropyl cellulose, polyvinyl pyrrolidone, carboxymethyl cellulose, polyvinyl alcohol, sodium alginate, polyethylene glycol, xanthan gum, tragacanth gum, guar gum, acacia gum, arabic gum, polyacrylic acid, methylmethacrylate copolymer, carboxyvinyl polymer, amylose, high amylose starch, hydroxypropylated high amylose starch, hydroxypropylated high amylose starch, dextrin, pectin, chitin, chitosan, levan, elsinan, collagen, gelatin, zein, gluten, soy protein isolate, whey protein isolate, casein, polysaccharides, natural gums, polyacrylates, starch, karaya gum, gelatin, and mixtures thereof.

The biodegradable carrier may preferentially be composed of pullulan. Pullulan content products in the form of fast-dissolving films are described in U.S. Pat. Nos. 5,518,902 and 5,411,945 to Ozaki et al., U.S. Pat. No. 4,851,394 to Kubodera, U.S. Pat. Nos. 3,784,390 and 4,562,394 to Hijiya et al., U.S. Pat. No. 4,623,394 to Nakamura et al., JP Patent Document JP5-1198, WO 99/17753, WO 98/26780, WO 98/20862, and WO 98/26763. The contents of all of these documents are incorporated herein by reference. Formation of film is described, for example, U.S. Patent Application 2003-30224090 to Pearce et al., the contents of which are incorporated herein by reference.

The biodegradable carrier may preferentially be composed of polyvinyl alcohol, and preferentially a polyvinyl alcohol in the form of a film. Polyvinyl alcohol films are commercially available from MonoSol (Portage, Ind.). Examples thereof are MonoSol® films E-6030, M-7031, M-7061, M-8534, M-8630, and M-9500. Monosol® films are environmentally acceptable, non-toxic, fully biodegradable, and can be sealed by heat. They are dissolvable in hot and/or cold water. These biodegradable carriers are described in U.S. Pat. No. 6,787,512 to Verrall et al., and U.S. Pat. No. 6,484,879 to Desmarais et al. The contents of these patents are hereby incorporated by reference.

The biodegradable carrier may be in any shape, and may have a slit or slits, a hole or holes, a pore or pores, or any other type of suitable opening to enhance biodegradation. The skilled artisan would understand that the rate of degradation of the biodegradable carrier may be controlled by selecting the kind and properties of the material thereof. For example, the diameter and shape of the pores, the size and shape of the carrier, etc. are suitably selected in consideration of the material. In selecting the above requirements, the factors to be considered in connection with the degradation rate include the kind, amount, and carrier-degradation activity of the microorganism, and the volume of the pollutant to be remediated.

Any and all of the biodegradable carriers mentioned herein can be coated with a slow-dissolving time-release agent, allowing longer release time and a more equalized disbursement of the microbes.

The microorganisms, in the form of a powder as commercially available, or in the form of a compressed tablet, or a powder made from the tablet, are packaged directly in contact with a biodegradable carrier to achieve bioremediation without producing unwanted debris. The biodegradable carrier housing the microbes serves two purposes.

First, the biodegradable carrier serves as a jacket, protecting the tablets or powder, etc. from excess moisture or crushing, and preventing premature disintegration and release of microbes. Within the flexible jacket, the substance of the tablets or powder, etc. is not lost, even if crushed.

Additionally, the biodegradable carrier may be selected based on its degradation rate in water, thereby allowing for a release of the microbes over time. The biodegradable carriers can be trolled through water spills and cover a much larger area with microbes than if the microbes were merely dropped directly into the water.

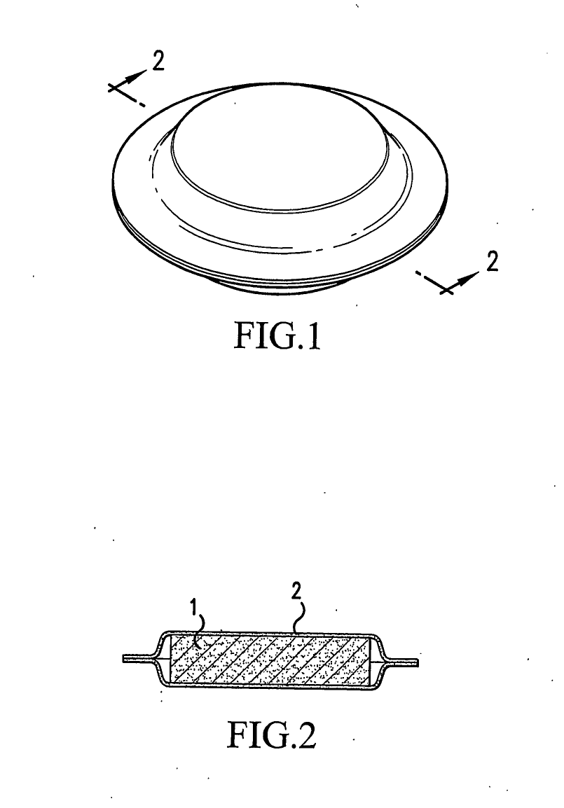

The invention provides microbe-bearing tablets sealed within two or more sheets of a biodegradable carrier, as shown in FIG. 1. In one embodiment the biodegradable carrier is comprised of two sheets of wrapping paper having a content of cornstarch or other suitable biodegradable material. In one form, as shown in FIG. 2, the mixture of microbes, inert material, and trace crude oil 1 are encased between layers of cornstarch paper or rice paper 2, and moisture or adhesive holds the carrier layers closed.

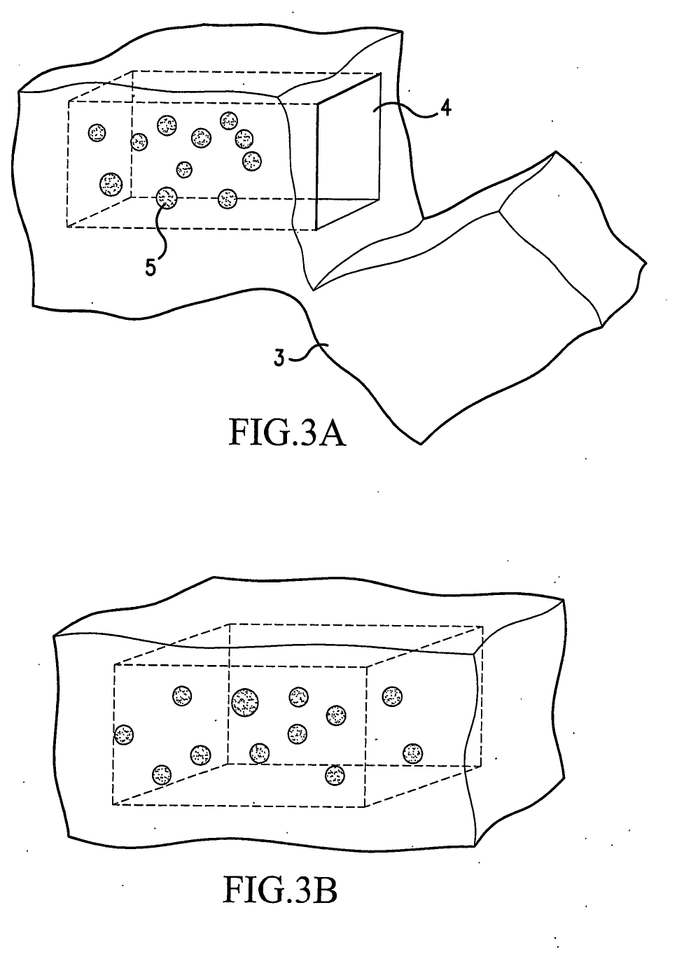

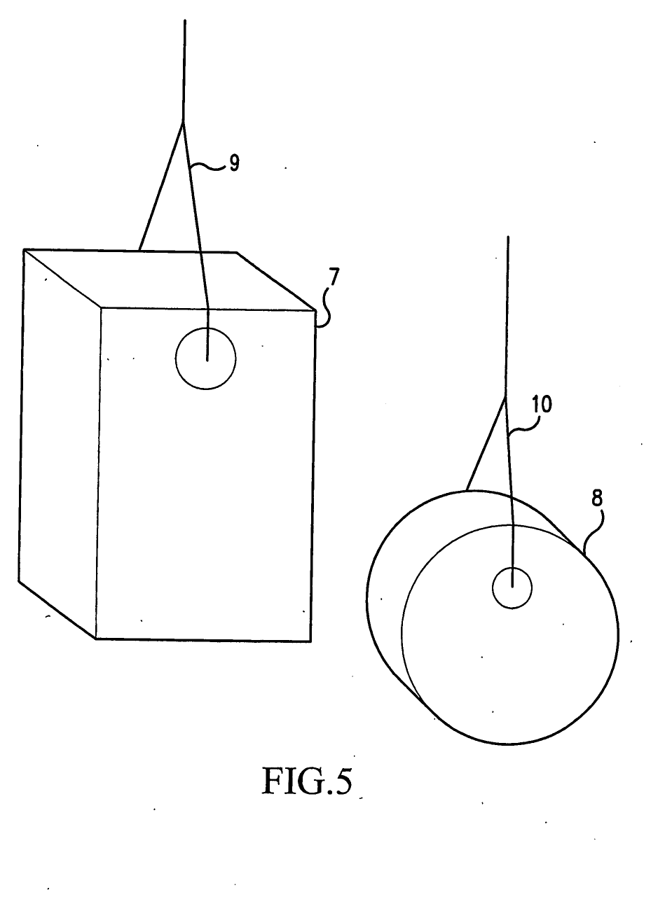

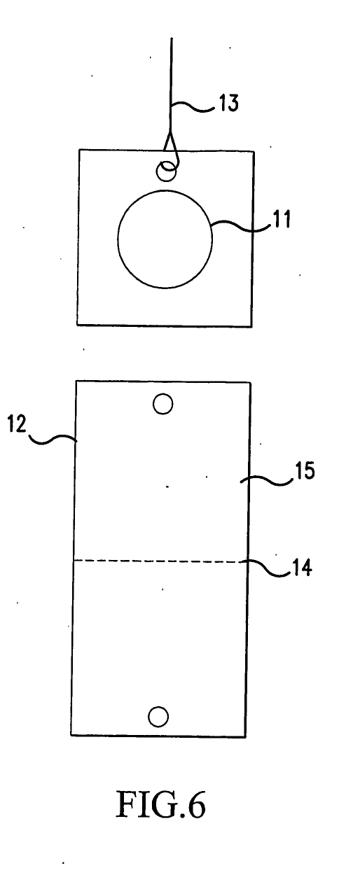

FIG. 3A shows a block of biodegradable cornstarch 3 sliced open and containing a hollow cavity 4. Microbes 5 are inserted into the hollow cavity, and then the cut is sealed with moisture or glue to reform the whole block, as shown in FIG. 3B. FIG. 5 shows microbe-bearing biodegradable carriers 7,8 suspended by tethers 9,10. FIG. 6 shows microorganisms 11 in a compressed tablet or powder form between dissolvable paper sheets 12 suspended by a tether 13. The microbes are encased by the biodegradable carrier, which is folded along a center-line 14 and secured with moisture or glue along the edges 15. The apparatus shown in FIG. 6 may or may not have a tether.

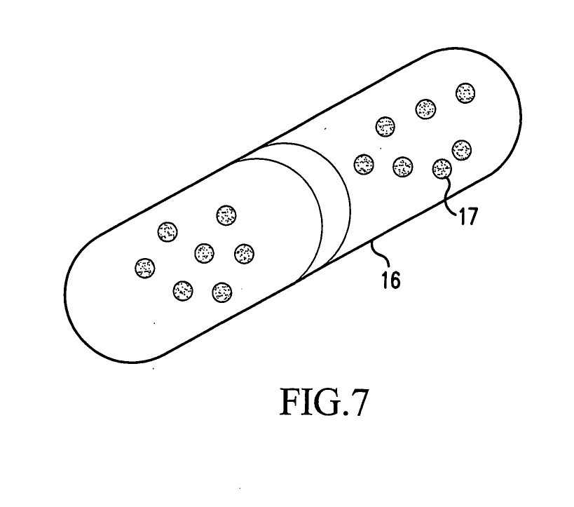

FIG. 7 shows a 2-piece cellulose gel-pack 16 which contains microbes, preferably admixed with clay and a trace amount of crude oil, in tablet form 17.

The product of the present invention may be produced as follows.

In one embodiment, to encase the microbe-containing tablets in the biodegradable carrier, the tablets are placed in a hopper and fed through a die molder and cutter. The biodegradable carrier is in the form of cornstarch wrapping paper or rice paper. The paper is drawn and then spooled from two supply rolls, one on either side of a tablet dispenser. The tablets are then pressed between two wrapper sheets by the die molding. The wrapper sheets are sealed via a solvent-based joint or seal, which joint or seal is 100% natural and biodegradable, such as water, epoxy, starch- or sugar-based glue. Cutters trim, cut and remove the excess paper wrapper, and the wrapped tablet is expelled with perforations for ease of dispensing. The excess paper wrappers with the punched out holes are spooled and bundled onto a scrap roller for recycling.

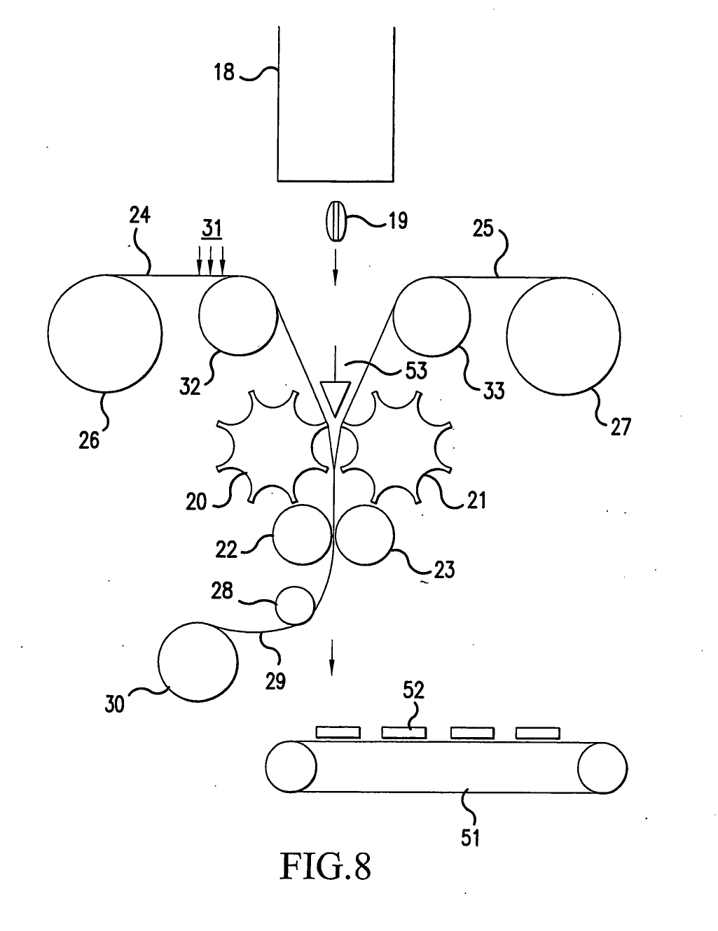

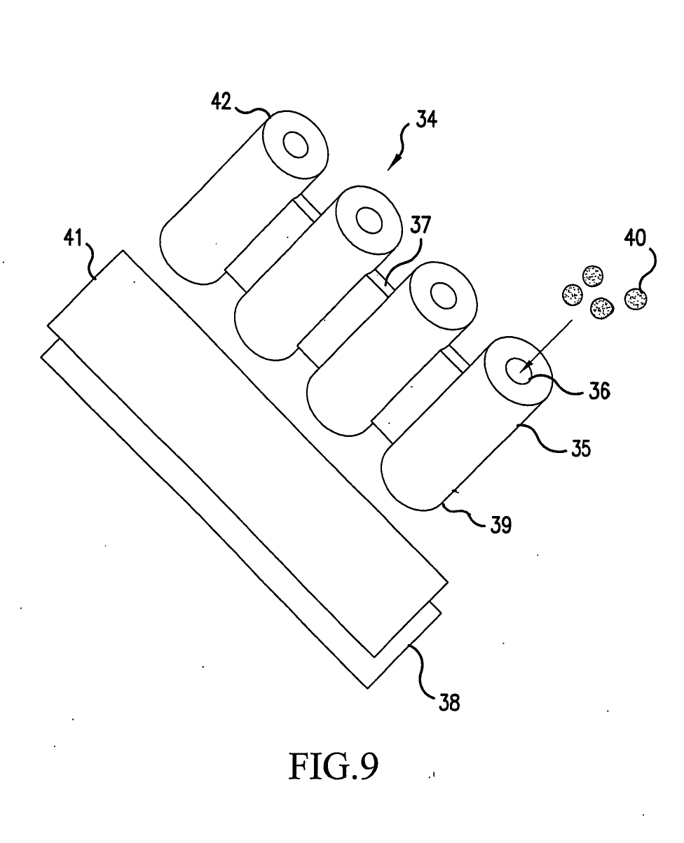

This embodiment is specifically shown in FIG. 8. FIG. 8 shows a tablet hopper 18 feeding microbe-containing tablets 19 into a die molder 20,21 and cutter 22,23. Sheets of biodegradable carrier in the form of wrapping sheets 24,25 are spooled from two supply rolls 26,27, one on either side of the tablet 19, via spooling rollers 32,33. Solvent 31 is applied to the biodegradable carrier. The tablet 19 is then pressed between the two sheets 24,25 by the die molding 20,21 and sealed with moisture 31. A cutter 22,23 slices away the excess wrapper 29 and the jacketed tablet is expelled. A stripping wheel 28, strips excess wrapper 29 and bundles it onto a scrap roller 30. Preferably, a drying conveyor 51 carries away the finished product 52. The apparatus may also utilize a tablet inserter assist 53.

The wrapper paper may also be preformed into casings for microbe tablet reception. One form is small connected and aligned cylinders with central voids for receiving the tablets, and first and second thin layers for closing the ends of the central voids. The microbe tablets are inserted into fluted openings in the shell, and then a layer of wrapper paper is secured across the top and bottom of the fluting, sealing the microbe-bearing tablets within the shell. The resulting soluble shell is both more buoyant and impact resistant than the paper wrapping and degrades over a longer period of time, due to its increased mass.

This embodiment of the present invention is shown in FIG. 9. FIG. 9 shows a series 34 of cylindrical, biodegradable tubular casings 35 with hollow tubular openings 36 and with connecting web 37. A bottom layer of biodegradable sheet strip 38 is secured across the bottom 39 of the cylinders 35 with an adhesive, e.g., water or glue. Microbes in powder or tablets 40 are inserted into the openings 36. A layer of biodegradable carrier 41 is secured across the top 42 of the cylinders 35, sealing the openings 36. The web may be separated such as by tearing web 37 and strips 38,41 to produce individual closed tubes for distribution over a spill.

Another form of casing is a single strip of cornstarch. The strip is sliced open longitudinally and the microbe tablets are inserted into a hollow between the layers and in openings. The layers of the strip are then rejoined and sealed with moisture or adhesive, encasing the microbe-bearing tablets within the strips. The strips may be cut into blocks or may be partially separated into tearable blocks for scattering over a spill on land and/or water. Greater buoyancy and impact resistance are achieved with these strips and blocks casing, as well as a slow rate of degradation, if desired.

In a similar procedure, a sheet of biodegradable cornstarch is divided into strips and is slit longitudinally into layers. The layers are joined together in alternating joints similar to web 37, leaving openings similar to openings 36 in tubular casings 35. Microbe-containing tablets or powder 40 are added to the openings, which are closed by sealing tops and bottoms or by pressing the layers together between the joints to entrap the microbe tablets or powder. Alternatively, the strips are split longitudinally and the microbe tablets or powder are inserted between the strips before dampening the strips and pressing them back together. In the latter cases the strips may be partially cut transversely into separable blocks. Alternatively, the tubular casings may be arranged as a floating barrier allowing water and hydrocarbon penetration to dissolve the biodegradable carrier while the microbes are released to do their work.

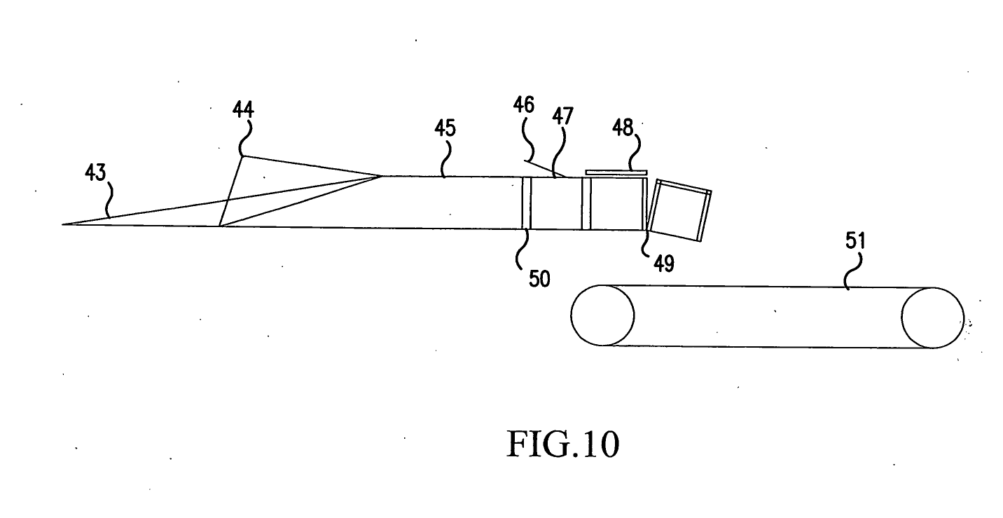

FIG. 10 shows an apparatus for making packets containing the microorganisms in powder form. A flat roll stock 43 of biodegradable carrier is fed into the machine and folded by a plow fold 44. Solvent 45 is applied to the biodegradable carrier. The plow is opened at the traveling/opening plow 46 and sealed at the sealer 50. An auger filler 47 inserts the microorganisms in powder form into the biodegradable carrier. The top is sealed 48 and cut by a cutter 49. Preferably, a drying conveyor 51 carries away the finished product.

It will be understood by those of ordinary skill in the art that other materials/fillers may be added to the product as desired to improve odor, etc. For example, the addition of fragrance or flavoring aromatic on the exterior of the cornstarch is useful for improving the odor of a holding tank. Preferably, however, the tablet or powder etc. contains only microorganisms together with an inert carrier (e.g., clay) when necessary without any other additive or component introduced therein. The tablet or power is then placed in direct contact with a biodegradable carrier preferably without any other intervening material between the tablet/powder etc. and biodegradable carrier. That is, the tablet or power is preferably in direct contact with the biodegradable carrier.

The invention provides a method of reducing or eliminating pollutants through bioremediation comprising providing microorganisms in the form of tablets or powder, incorporating the microorganisms into a biodegradable carrier, delivering the carrier with the microbes to a contaminated site, dissolving or disintegrating the soluble carrier, releasing the microbes from the carrier, and digesting hydrocarbons and organic pollutants at the contaminated site with the microbes.

The product of the present invention can be used effectively on any of the following materials: acenapthene, alkylamine oxides, benzene, chlorinated phenols, chloro naphthalene, cyanide, diethleneglycol, fuel oils #1-6, heptane, isoprene, long chain alkenes, mercaptan, motor oils (not synthetic), nitrated phenols, oil based paints, pentane, phthalate esters, secondary alkylbenzene, trichloroethylene, xylene, acrolein, animal (including human) wastes, biphenyl, chlorobenzene, crude oil, dichlorobenzene, ethylbenzene, gasoline, hexane, hexane, jet fuels, lubricating oils, methylene chloride, MTBE, oil based fluids, organic herbicides, phenoxyacetates, polycyclic aromatics, sewage, vegetable oils, acrylonitrile, aromatics, brake fluids, chloroform, cutting oils, diesel fuels, fluoranthene, grease, hydraulic oils, kerosene, marine fuels, monoalkylbenzenes, naphthalenes, oil based inks, organic pesticides, phenylureas, pulp by-products, toluene, and volatile organic compounds (VOCs).

Upon delivery to the contaminated site, the biodegradable carrier begins to dissolve, allowing the water and hydrocarbons to access the microbes. As the clay disintegrates, the microbes are released into the contaminants and begin converting the hydrocarbons to natural byproducts. As the microbes feed on the hydrocarbons, the population of microbes increases, allowing faster and more effective contaminant reduction.

This increased population of microbes is sustainable only as long as sufficient hydrocarbons remain. Once the hydrocarbons have been remediated, the microbes die, return to initial levels, or are consumed by other organisms in the environment.

The product of the present invention may be distributed over oil spills from airplanes or helicopters or high-speed boats or from a ship from which the spill originated. The product may also be deployed in storm water catch basins or grease traps. The product may be suspended from tethers into contaminated areas. As biodegradable carrier dissolves, the tablets disintegrate and the contaminants are exposed to the microbes within the carrier.

A preferred method for destroying contaminant hydrocarbons places tableted (e.g., with clay) microbes or powder into dissolvable, degradable or disintegratable floaters (e.g., comprising about 50-99% by weight cornstarch and about 50-1% by weight binder), formed as a paper or cellular carrier adapted to float in or on the surface of the body of water. The floaters containing the microbes are placed on pollution in a body of water. The floaters become wet and dissolve, degrade or disintegrate, and the contaminant hydrocarbons come into contact with the microbes from the floaters. The microbes then digest the contaminant hydrocarbons. Preferable carriers or floaters contain 90% or more cornstarch or other suitably biodegradable material.

While the invention has been described with reference to specific embodiments, modifications and variations of the invention may be constructed without departing from the scope of the invention, which is defined in the following claims.

We claim:

1. A product for bioremediation, comprising a biodegradable carrier and
a tablet or powder consisting essentially of microorganisms capable of digesting hydrocarbons, an inert material, and optionally trace oil in an amount sufficient to maintain the microorganisms in a dormant state,
said tablet or powder located entirely within said biodegradable carrier, and wherein the biodegradable carrier is directly in contact with said tablet or powder.

2. The product of claim 1, wherein the biodegradable carrier is cornstarch.

3. The product of claim 1, wherein the microorganism is from the domain Archaea.

4. The product of claim 1, further comprising a fragrance.

5. The product of claim 1, wherein the biodegradable carrier comprises a hole, slit, opening, or pore.

6. The product of claim 1, which does not contain at least one of the following selected from the group consisting of one or more amino acids, nucleic acid bases, vitamins, organic acids, growth factors, wax, and enzymes in the biodegradable carrier, tablet, powder, or inert material.

7. A method for bioremediation, comprising the steps of
delivering the product of claim 1 to a contaminated site,
allowing the biodegradable carrier to dissolve,
allowing the microorganisms to be released into the contaminants to begin converting the contaminants to natural byproducts.

8. A process for producing a product for bioremediation, comprising the steps of:
admixing microorganisms capable of digesting hydrocarbons with an inert material and optional trace oil in an amount sufficient to maintain the microorganisms in a dormant state to form a mixture;
placing the mixture into preformed holes of a tablet-making template, wherein the tablet-making template is a foam;
placing the tablet-making template onto a compression press;
applying pressure to the tablet-making template to form at least one tablet;
extracting the at least one tablet from the tablet-making template; and
placing at least one of the at least one tablet into a biodegradable carrier wherein the biodegradable carrier surrounds the tablet and is in direct contact with the tablet.

9. The process of claim 8, wherein the biodegradable carrier is a starch.

10. The process of claim 8, wherein the biodegradable carrier is cornstarch.

11. The process of claim 8, wherein the microorganism is from the domain Archaea.

12. The process of claim 8, further comprising the step of inserting a hole, slit, or pore in the biodegradable carrier.

13. The process of claim 8, further comprising a step of adding a fragrance to the biodegradable carrier.

14. The process of claim 8, wherein the inert material is selected from the group consisting of clay and bentonite clay.

15. A product for bioremediation, comprising microorganisms capable of digesting hydrocarbons and a biodegradable carrier, wherein the biodegradable carrier is directly in contact with the microorganisms, wherein the product is produced by the process of claim 8.

16. A method for bioremediation comprising
providing microorganisms capable of degrading hydrocarbons in the form of a tablet or powder,
incorporating said microorganisms into a biodegradable carrier, wherein the tablet or powder is in direct contact with the biodegradable carrier, delivering the biodegradable carrier containing the microorganisms to a contaminated site, wherein the biodegradable carrier is dissolved or disintegrated, thereby releasing the microorganisms which bioremediate at the contaminated site.

17. The method of claim 16, wherein the microorganism is from the domain Archaea.

18. The method of claim 16, wherein the biodegradable carrier is cornstarch.

19. A method for neutralizing odors in a holding tank, comprising the steps of delivering the product of claim 1 to the holding tank, allowing the biodegradable carrier to dissolve, and allowing the microorganisms to be released into the holding tank to neutralize the odors into natural byproducts.
